(19) United States
(12) Patent Application Publication
(10) Pub. No.: US 2021/0172138 A1
(43) Pub. Date: Jun. 10, 2021

(54) FLOATING FLAP GATE APPARATUS

(71) Applicant: HITACHI ZOSEN CORPORATION, Osaka (JP)

(72) Inventors: Toshiaki MORII, Osaka (JP); Kyouichi NAKAYASU, Osaka (JP); Yoshito YAMAKAWA, Osaka (JP); Yuuichiro KIMURA, Osaka (JP)

(21) Appl. No.: 16/087,365

(22) PCT Filed: Feb. 17, 2017
(86) PCT No.: PCT/JP2017/005943

§ 371 Date: Sep. 21, 2018

(30) Foreign Application Priority Data
Mar. 23, 2016 (JP) 2016-58542

(51) Int. Cl. E02B 7/44; E02B 7/50

(52) U.S. Cl. CPC E02B 7/44; E05Y 2900/40; E02B 7/50

(57) ABSTRACT

To effectively block a corner portion from an influx of water. A floating flap gate apparatus 1 constructed to enable a forward end of a door body to swing upwards around a base end thereof. The floating flap gate system 1 has floating flap gates 11 and 12 arranged in a first rectilinear region S1 and a second rectilinear region S2 respectively, and a corner flap gate 21 installed at a corner portion C where S1 and S2 intersect. The corner flap gate 21 has a plurality of door bodies 22 divided by straight lines passing through a part of the corner portion C where lines extending in a width-wise direction of a base end side bottom surface of the door bodies 13 of the floating flap gates 11 and 12 intersect. Among the plurality of door bodies 22, a door body adjacent to the door bodies 13 of the floating flap gates 11 and 12 and the door bodies 22 adjacent to the door bodies 13 are connected by hinge structures 32 and 31 that maintain a water-impervious state. The corner flap gate rises or lowers, following a raising or a lowering of the door bodies of the floating flap gates, thereby making it possible to effectively block a corner portion from an influx of water.

### TECHNICAL FIELD

The present invention relates to a floating flap gate apparatus for preventing an influx of a rising water, and in particular, the present invention relates to a floating flap gate apparatus that makes it possible to effectively prevent an influx of water when a corner portion is present.

### BACKGROUND ART

A floating flap gate exists which blocks an opening to a living space or an underground space at the time of a rising water in order to prevent the rising water from flowing into the living space or the underground space, by causing a door body to float, using a buoyancy of the water which is trying to flow in (e.g., Patent References 1 and 2).

The floating flap gates disclosed in Patent Reference 1 and Patent Reference 2 have a door body opening and closing auxiliary mechanism, and thus, the floating action of a door body is delayed at an initial stage of water influx, so the water does not flow into a living space or into an underground space, and it does not become difficult to lower the door body even when a water level is low, and the door body also does not suddenly fall.

The door body opening and closing auxiliary mechanism disclosed in Patent Reference 1 and Patent Reference 2 is constructed with a rope having a counterweight attached to a forward end of a door body, and with the other end attached to a counterweight or spring via a pulley, with the pulley installed so that the counterweight reaches its lowest point or the spring reaches its free length while the door body is rising or descending.

In Patent Reference 1, the auxiliary opening and closing mechanism of the door body is provided inside a stopper disposed on an inner side of a lowered door body. In Patent Reference 2, the auxiliary mechanism of the door body is provided inside a housing disposed in a position relative to a place where the rope is attached on both sides of a forward end surface of the door body.

That is to say, the auxiliary opening and closing mechanism assists in opening and closing the door body from both side portions of the door body. Therefore, when the width (span) of the door body increases, it becomes difficult to assist in opening the door body, so a limit was placed on the span of the door body.

Because of the above, there is a need to provide a land-based structure such as a stopper or a housing in a width-wise central portion of the door body when the span of the door body increases in cases where the auxiliary opening and closing mechanism of the door body disclosed in Patent Reference 1 or Patent Reference 2 is employed.

However, in cases where the auxiliary opening and closing mechanism of the door body disclosed in Patent Reference 1 and Patent Reference 2 is employed, it is impossible to install a land-based structure in a width-wise central portion of the door body. Also, the auxiliary opening and closing mechanism of Patent Reference 1 and Patent Reference 2 cannot provide a solution in an application in which it is not desirable to install a land-based structure in such a width-wise central portion of the door body.

Moreover, there are also cases in which parts of the above floating flap gate that prevent an influx of water has not only a rectilinear region, but also a corner portion. In cases where such a corner portion is present, a stopper is provided that corresponds to the corner portion, making it impossible to form a water-impervious wall continuous with the corner portion, thus making it impossible to effectively block the corner portion from an influx of water.

### PRIOR ART REFERENCES

### Patent References

Patent Reference 1: Japanese Patent Application Kokai Publication No. 2012-241449

Patent Reference 2: Japanese Patent Application Kokai Publication No. 2014-118774

### SUMMARY OF THE INVENTION

### Problems to be Solved by the Invention

The problem that the present invention aims to solve is that in cases where a corner portion is present in an installation portion of a floating flap gate apparatus, it is impossible to form a water-impervious wall that is continuous with the corner portion, thus making it impossible to effectively block the corner portion from an influx of water.

The present invention was devised with the object of effectively blocking a corner portion present in an installation portion of a floating flap gate apparatus from an influx of water by forming a water-impervious wall that is continuous with the corner portion.

The present invention is a floating flap gate apparatus constructed to prevent an influx of a rising water, the floating flap gate comprising a door body configured such that a forward end of the door body swings upwards around a base end thereof within a plane in a height direction in a direction in which the water flows in, and having the following as its most essential features.

The floating flap gate apparatus according to the present invention comprises a floating flap gate arranged in a first rectilinear region, a floating flap gate arranged in a second rectilinear region, and a corner flap gate disposed in a corner portion where the first and second rectilinear regions intersect.

The corner flap gate has a plurality of door bodies divided by straight lines passing through a part of the corner portion where lines extending in a width-wise direction of a base end side bottom surface of the door bodies of the two floating flap gates intersect, and two adjacent ones of the plurality of door bodies are connected by a hinge structure that maintains a water-impervious state, and among the plurality of door bodies, a door body adjacent to a door body of the floating flap gates and the door body of the floating flap gate are connected by a hinge structure that maintains the respective water-impervious states.

According to the present invention configured as described above, the corner flap gate rises or lowers, following a raising or a lowering of the door bodies of the floating flap gates, thereby making it possible to effectively block the corner portion continuously.

In the present invention, the corner flap gate is formed on a base end side of the plurality of door bodies with a notched site that includes the part intersected by the corner portion, and if the notched site is covered with a water-impervious membrane that maintains a water-impervious state in the hinge structure, then it is possible to smoothly raise or lower each of the door bodies.

In the present invention, the angle of the corner portion may be 90° or more, or less than 90°, and the two floating flap gates are arranged in such a manner that a side surface of the second rectilinear region side of a door body of the floating flap gate arranged in the first rectilinear region in a lowered state, and a bottom surface of a gate body of a floating flap gate arranged in the second rectilinear region in a lowered state, are formed in a single straight line when viewed from above.

As long as there is a plurality of door bodies forming the corner flap gate in the present invention, the number thereof is not limited, but a configuration having three door bodies comprising a central door body, and a right-side door body and a left-side door body arranged on both sides of the central door body, is desirable from the standpoint of an ability to follow a raising or lowering of the door bodies of the floating flap gates.

According to the configuration described above, when the door bodies are lowered, the central door body, the right-side door body, and the left-side door body are flat; and when the door bodies are raised, the right-side door body and the left-side door body approach each other and fold into each other with respect to the central door body, making it possible to easily form a water-impervious wall continuous with the corner portion. When this happens, the interfolding of the central door body, the right-side door body, and the left-side door body makes it possible to absorb a difference of in a raising angle of the adjacent floating flap gate door bodies, even if different wave forces or wave directions operate on the adjacent floating flap gate door bodies, resulting in an occurrence of an instantaneous difference in water levels.

In the present invention, if a hinge structure is arranged on a surface side of the two floating flap gates and the corner flap gate in a lowered state, it is desirable, since there is no risk of an overflow of water flowing onto a top side of the hinge portion, as was the case when a hinge structure was attached to a back side.

### Advantageous Effects of the Invention

According to the present invention, even in a case where a floating flap gate apparatus is installed at a location in which a corner portion is present, the corner flap gate raises or lowers, following a raising or a lowering of the door bodies of the floating flap gates, thereby making it possible to effectively block the corner portion.

### BRIEF DESCRIPTION OF THE DRAWINGS

FIGS. 1A through 1C are schematic structural drawings of the first floating flap gate apparatus according to the present invention, where the angle of the corner portion is 90°. FIG. 1A is an elevated view of a lowered state. FIG. 1B is an elevated view of a raised state. FIG. 1C is a side view of a corner portion in a raised state.

FIGS. 2A through 2D are drawings illustrating a hinge structure of a connecting part for the flap gate door bodies of the corner portion and the door bodies of the adjacent floating flap gates of the first floating flap gate apparatus according to the present invention. FIG. 2A is an elevated view. FIG. 2B is an enlarged view of part A in FIG. 1A. FIG. 2C is an enlarged sectional view along the line B-B in FIG. 2B. FIG. 2D is an enlarged sectional view along the line C-C in FIG. 2B.

FIG. 3A is an enlarged sectional view along the line E-E in FIG. 2A.

FIG. 3B is an enlarged sectional view along the line D-D in FIG. 2A. FIG. 3C is an enlarged sectional view of part F in FIG. 3B.

FIGS. 4A through 4C are elevated views of a water-impervious structure of the first floating flap gate apparatus according to the present invention. FIG. 4A is a drawing illustrating a divided state of a door body of a corner flap gate. FIG. 4B is a drawing illustrating a water-impervious membrane provided to a floating flap gate and a corner flap gate. FIG. 4C is a drawing illustrating a presser plate of the water-impervious membrane.

FIGS. 5A through 5C are drawings illustrating a raised state of a door body of the first floating flap gate apparatus according to the present invention when an instantaneous difference in water level occurs. FIG. 5A is an elevated view. FIG. 5B is a side view of a floating flap gate installed in the first rectilinear region. FIG. 5C is a side view of a floating flap gate installed in the second rectilinear region.

FIG. 6 is a drawing illustrating an interfolding auxiliary mechanism of a corner flap gate door body in the floating flap gate apparatus according to the present invention.

FIGS. 7A and 7B are drawings illustrating a water pressure load support structure when a door body of a corner flap gate of the first floating flap gate apparatus according to the present invention in a lowered state. FIG. 7A is an elevated view. FIG. 7B is a side view of a floating flap gate installed in the second rectilinear region.

FIGS. 8A and 8B are schematic structural drawings of a floating flap gate in a floating flap gate apparatus according to the present invention. FIG. 8A is a side view. FIG. 8B is a frontal view.

FIGS. 9A through 9D are drawings illustrating various states of a storage area for a floating flap gate and a corner flap gate in a floating flap gate apparatus according to the present invention.

FIG. 10 is a drawing illustrating another example of a hinge structure of a connecting part for the left-side door body and the central door body of a corner flap gate in the first floating flap gate apparatus according to the present invention.

FIGS. 11A through 11E are schematic drawings illustrating an example of deformation of the first floating flap gate apparatus according to the present invention in a lowered state as seen from above. FIG. 11A illustrates a case where the angle of the corner portion is less than 90°. FIG. 11B illustrates a case where the angle of the corner portion exceeds 90°. FIG. 11C illustrates a care where the width of the base end side of the central door body is at a minimum. FIG. 11D is an enlarged view of part G in FIG. 11C. FIG. 11E illustrates an example of a case where the left-side door body and the central door body are equally divided.

FIGS. 12A and 12B are schematic structural drawings of the second floating flap gate apparatus according to the present invention configured with a corner flap gate having two door bodies. FIG. 12A is an elevated view of a lowered state. FIG. 12B is an elevated view of a raised state.

FIG. 13 is an elevated schematic structural drawing of the third floating flap gate apparatus according to the present invention configured with a corner flap gate having four door bodies.

### EMBODIMENTS

The present invention was devised with the object of forming a water-impervious wall that is continuous with a corner portion that is present in an installation portion of a floating flap gate apparatus, to effectively block the corner portion.

The above object is achieved by using a hinge structure that maintains a water-impervious state to connect (1) adjacent door bodies of a corner flap gate installed in a corner portion where a first rectilinear region where a floating flap gate is arranged intersects with a second rectilinear region, (2) a door body of a floating flap gate, and (3) a door body adjacent to these door bodies.

### EXAMPLES

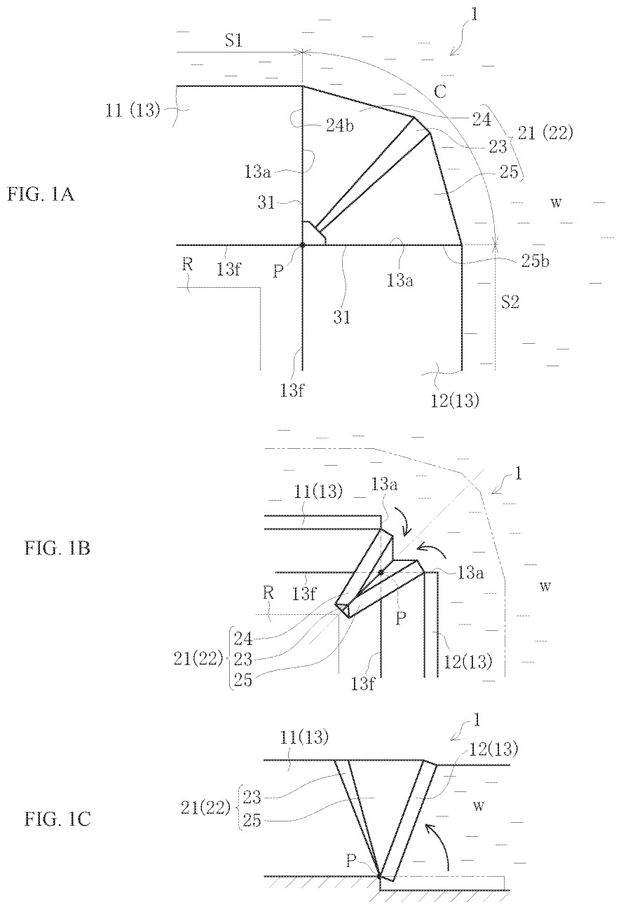

An embodiment of the present invention is described in detail, making use of FIG. 1 to FIG. 9. Reference Numeral 1 is a floating flap gate apparatus according to the present invention installed at an end portion of a runway R, for example, in such a manner that a plurality of door bodies are disposed in a lowered state substantially in the same plane as the runway R. In an event of a tsunami, for example, the apparatus uses a pressure of a surging water w to swing a forward end side of a door body upwards using a base end side as a fulcrum, following the surging water w, to prevent the water w from flowing into the runway R.

In detail, the floating flap gate apparatus 1 of the present invention comprises floating flap gates 11 and 12 respectively arranged in a first rectilinear region S1 on one side and in second rectilinear region S2 on another side that intersect at an angle of 90°, for example, and a corner flap gate 21 installed in a corner portion C where the two rectilinear regions S1 and S2 intersect.

The floating flap gates 11 and 12 are, for example, installed in such a manner that each respective end portion of a bottom surface 13f of a base end side of a plurality of door bodies 13 approach or come into contact at a part that includes a point P where a line extending toward a width-wise direction of a bottom surface 13f of a base end side of the door bodies 13 that are connected in a width-wise direction intersects with the corner portion C. In this case, when viewed from above, a side surface 13a of the door body 13 of the floating flap gate 11 (or 12) installed at the first rectilinear region S1 (or at the second rectilinear region S2) in a lowered state forms a straight line with a side surface 13f of the door body 13 of the floating flap gate 12 (or 11) installed at the second rectilinear region S2 (or at the first rectilinear region S1) in a lowered state.

On the other hand, the corner flap gate 21 covers an interval between the adjacent door bodies 13 of the floating flap gates 11 and 12. There are also provided three door bodies 22: a central door body 23, for example, that is divided by a straight line passing through the part that includes the point P of the corner portion C, as well as a right-side door body 24 and a left-side door body 25 arranged on both sides of the central door body 23.

The part that includes the point P of the corner portion C includes not only the single point referred to as P, but also includes the vicinity of the point P. In an actual operation, in order to achieve a smooth upward swing of the door bodies 22, some leeway is required when considering the manufacturing accuracy of the door bodies 22 and the hinge portion, because some deviation occurs regarding the point P that intersects at the corner portion C.

Among the three door bodies 22 of the corner flap gate 21, the right-side door body 24 and the left-side door body 25 have a floating structure. Also, a side surface 24b on the floating flap gate 11 side of the right-side door body 24 and a side surface 25b on the floating flap gate 12 side of the right-side door body 25 are connected to a side surface 13a of the adjacent door bodies 13 of the floating flap gates 11 and 12, by means of a hinge structure 31 that maintains each of them in a water-impervious state.

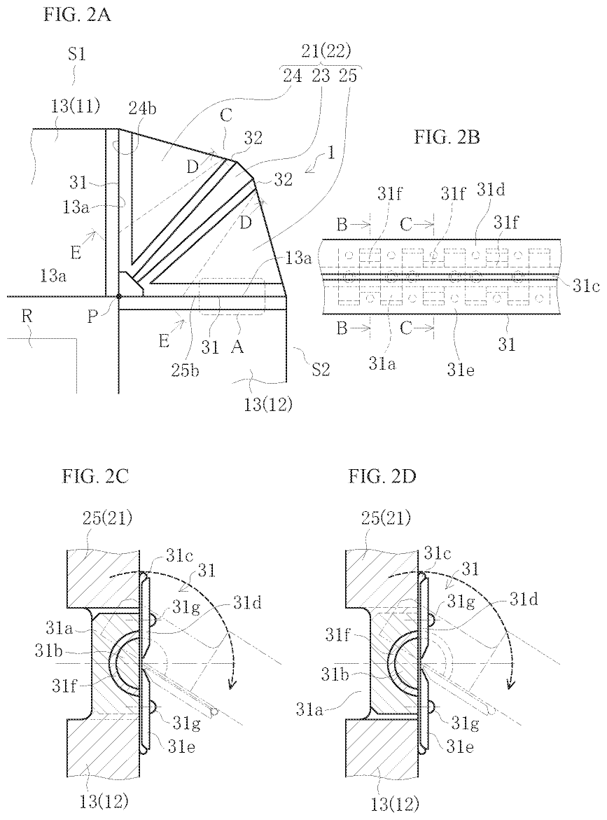

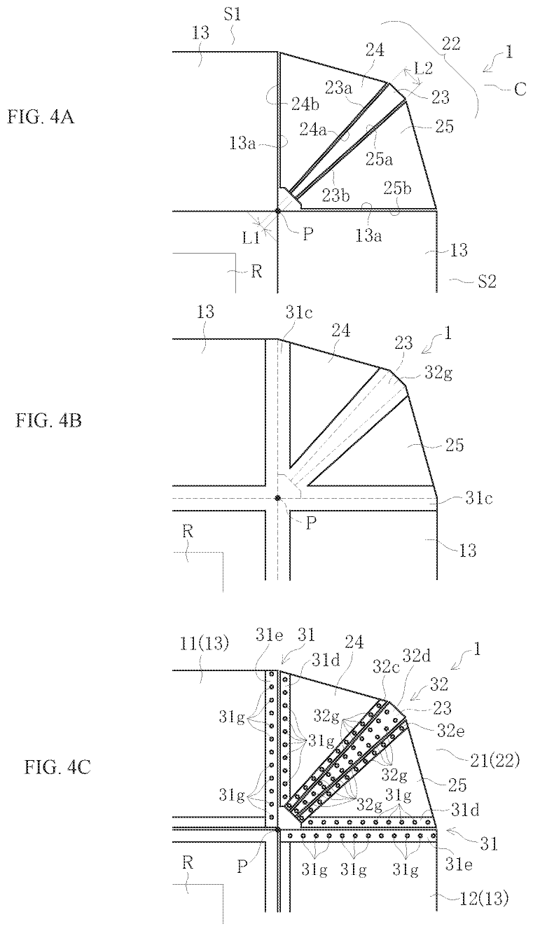

The hinge structure 31 is configured in a manner illustrated in FIGS. 2B through 2D and in FIGS. 4B and 4C, for example. That is to say, in a case where a lowered state is viewed from a top surface side, the side surface 24b on the floating flap gate 11 side of the right-side door body 24 and the side surface 25b on the floating flap gate 12 side of the right-side door body 25 are connected to the side surface 13a of the adjacent door bodies 13 of the floating flap gates 11 and 12, by forming interlocking parts that are caused to engage, with an interlocking engaging member 31a connected with a pin 31b that has a semicircular cross-section. Also, the top surface of the interlocking engaging member 31a that includes the pin 31b is pressed by a presser plate 31d on the corner flap gate 21 side via a water-impervious membrane 31c that serves as a hinge membrane and by a presser plate 31e on the floating flap gate 11, 12 side, thereby making it possible to stop water and to rotate. Reference Numeral 31f is a bushing that supports a free rotation of the pin 31b, and Reference Numeral 31g is a bolt for attaching the presser plates 31d and 31e.

Among the door bodies 22 of the corner flap gate 21, the right-side door body 24 and the central door body 23, and the central door body 23 and the left-side door body 25 are respectively connected by the hinge structure 32 that maintains each of them in a water-impervious state.

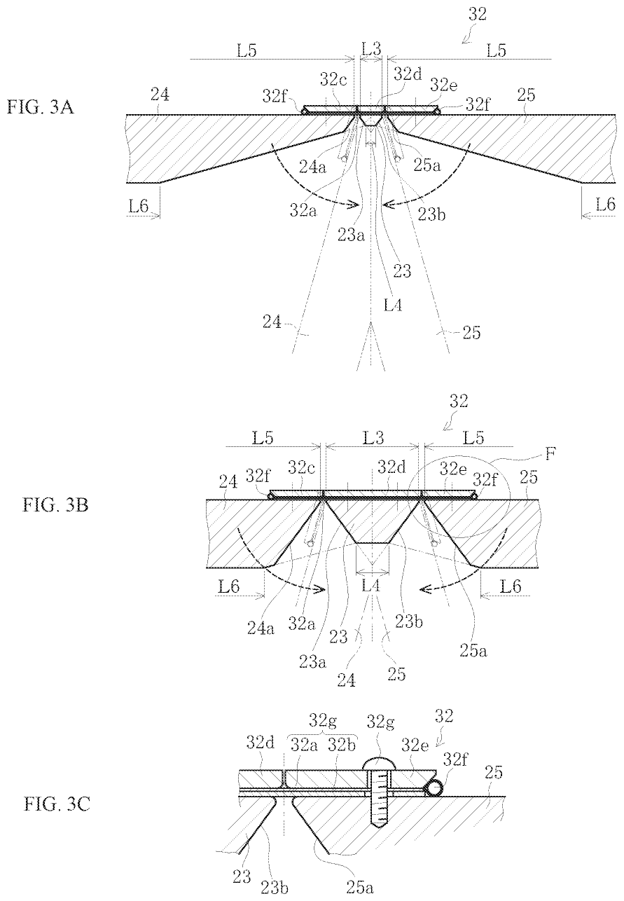

The hinge structure 32 is configured in a manner illustrated in FIGS. 3A through 3C and in FIGS. 4B and 4C, for example. That is to say, on a top surface side of the door bodies 22 in a lowered state, there is provided a rubber membrane 32a that serves as an elastic membrane seal that covers adjacent side surfaces 24a and 23a of the right-side door body 24 and the central door body 23, as well as adjacent side surfaces 23b and 25a of the central door body 23 and the left-side door body 25. The rubber membrane 32a has a sufficient tensile strength to withstand a load when a water pressure is applied, and is covered with a strong fiber membrane 32b having outstanding weather-resistant properties, to form a hinge membrane 32g. The rubber membrane 32a and the fiber membrane 32b are pressed by a presser plate 32c on the right-side door body 24 side, by a presser plate 32d on the central door body 23 side, and by a presser plate 32e on the left-side door body 25 side. When configured in this manner, it is possible to stop water and to rotate. Reference Numeral 32f is a rod for preventing the fiber membrane 32b from coming loose, and Reference Numeral 32g is a bolt for attaching the presser plate 32e.

As shown in FIG. 4A, the door bodies 22 of the corner flap gate 21 have a notched base end side that includes the point P intersecting at a corner portion C. As shown in FIG. 4B, this notched site is covered by the water-impervious membranes 31c and 32g to maintain a water-impervious state in the hinge structures 31 and 32.

In the event that a tsunami surges, for example, according to the corner flap gate 21 constructed as above, the door bodies 13 of the floating flap gates 11 and 12 installed at the two rectilinear regions S1 and S2 rise from the lowered state shown in FIG. 1A. When this happens, the door bodies 22 of the corner flap gate 21 also rise, as shown in FIGS. 1B and 1C, following the rising of the door bodies 13 of the floating flap gates 11 and 12.

Use of the floating flap gate apparatus 1 according to the present invention makes it possible to form a water-impervious wall continuous with the corner portion C, due to the fact that the floating flap gates 11 and 12 are connected by the corner flap gate 21 in the manner described above.

In the case of the floating flap gates 11 and 12, it is difficult to reach a maximum raising angle of 90° from a lowered state. This is because although the maximum raising angle is 90° if the floating flap gates 11 and 12 are by themselves, and do not include the corner flap gate 21, but in the present invention, the corner flap gate 21 is included. The reason for this is that, according to the present invention, when the floating flap gates 11 and 12 rise to a raising angle of 90°, the end portions of the floating flap gates 11 and 12 approach each other, and there is no longer space for the folded corner flap gate 21. Accordingly, the maximum raising angle is determined by devising an optimized design so as to make it possible to ensure that there is space for the folded corner flap gate 21. A maximum raising angle of 75° is advantageous for the floating flap gates 11 and 12.

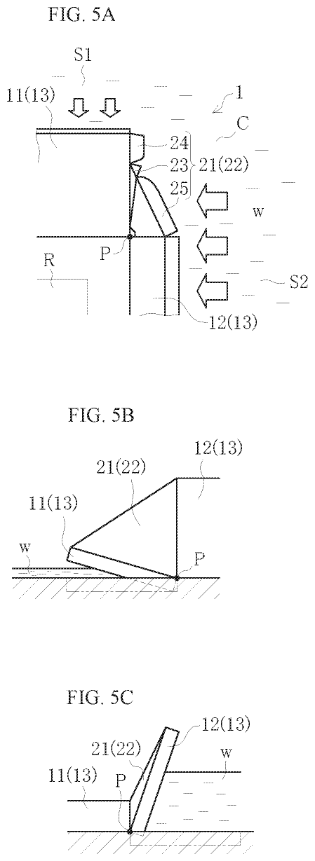

The above example describes a case where the force exerted by the surging waves on the rectilinear region S1 and on the rectilinear region S2 are of the same magnitude. However, as shown in FIG. 5, for example, if the force of a surging wave exerted on the rectilinear region S2 is greater than the force of a surging wave exerted on the rectilinear region S1, there results an instantaneous difference in water levels in the rectilinear regions S1 and S2. Even in such a case, the corner flap gate 21 is able to absorb a difference in the raising angle of the door bodies 13 of the floating flap gates 11 and 12.

Specifically, as shown in FIG. 5, when the door bodies 22 of the floating flap gate 21 are raised, the right-side door body 24 approaches and folds into the central door body 23 at a small raising angle, while the left-side door body 25 approaches and folds into the central door body 23 at a large raising angle. No matter what changes occur in the magnitude and direction of the waves surging onto the rectilinear region S1 and the rectilinear region S2, the folding configurations of the right-side door body 24 and the left-side door body 25 adapt optimally to the central door body 23, thereby making it possible to absorb a difference in the raising angle of the door bodies 13 of the floating flap gates 11 and 12.

In order to achieve a smooth folding of the central door body 23, the right-side door body 24, and the left-side door body 25, the adjacent side surfaces of the central door body 23 and the right-side door body 24, as well as the adjacent side surfaces of the central door body 23 and the left-side door body 25, may be formed as described below, for example.

As shown in FIG. 4A, the central door body 23 forms a trapezoid wherein a width L2 of a forward end side facing the forward end sides of the floating flap gates 11 and 12 is longer than a width L1 of a base end side facing the base end sides of the floating flap gates 11 and 12, while in a lowered state as viewed not only from the top surface side, but also from the back surface side at the bottom side of the paper in FIG. 4A. Additionally, as shown in FIGS. 3A and 3B, the central door body 23 forms an inverse trapezoid wherein a width L4 of a back surface side is shorter than a width L3 of a top surface side while in a lowered state.

On the other hand, with regard to the side surfaces 24a and 25a of the right-side door body 24 and the left-side door body 25 that face the side surfaces 23a and 23b that form the legs of the inverse trapezoid of the central door body 23, a width L6 of a portion parallel to the top surface side of the back surface side is shorter than a width L5 of the top surface side of the right-side door body 24 and the left-side door body 25 in a lowered state, and as the rate whereby the width becomes shorter increases, the base end side gradually becomes greater than the forward end side, so as to become disposed diagonally.

In addition, if an auxiliary force generator 33 is installed at the door body 13 adjacent to the side surface 24b of the right-side door body 24 of the corner flap gate 21 and at the side surface 25b of the left-side door body 24, in order to provide an auxiliary force in the folding direction of the right side door body 24 and the left-side door body 25, it becomes possible to smoothly perform folding of the right-side door body 24 and the left-side door body 25 at the initial stage of raising the corner flap gate 21.

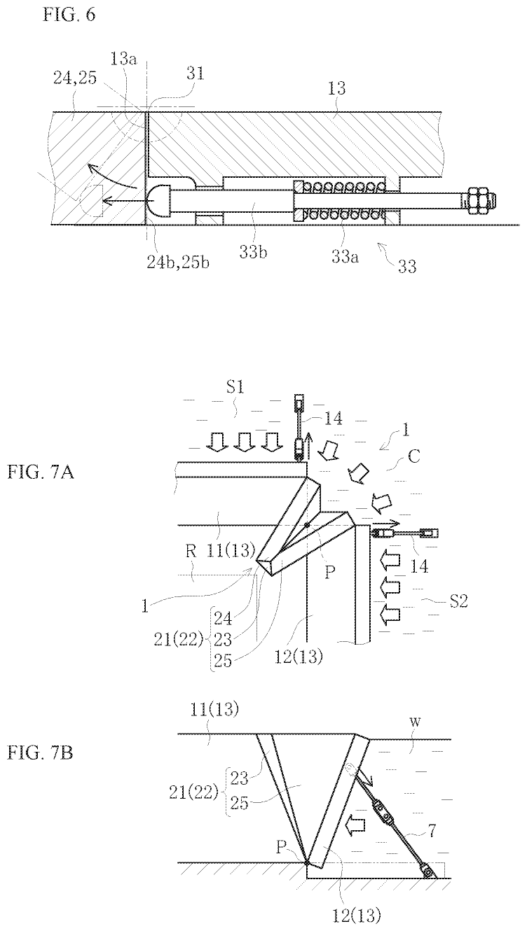

There are no particular restrictions on the configuration of the auxiliary force generator 33, but according to the example illustrated in FIG. 6, there is provided to the door body 13 of the floating flap gates 11 and 12 a push rod 33b projecting toward the side surface 24b of the right-side door body 24 or the side surface 25b of the left-side door body 25 of the corner flap gate 21 by means of a coil spring 33a. In this case, when the door body is being lowered, the coil spring 33a compresses and the push rod 33b presses against the side surface 24b of the right-side door body 24 or the side surface 25b of the left-side door body 25 of the corner flap gate 21, while being located inside of the door body 13 of the floating flap gates 11 and 12. Then, when the door body starts to rise, a compression of the coil spring 33a is released, projecting the push rod 33b, thereby pushing the right-side door body 24 and the left-side door body 25 in the folding direction thereof.

Although there are no particular restrictions on the installation location of the auxiliary generator 33, it is more effective to install it at the forward end side of the door body 13. There may be one or more than one of the auxiliary force generator 33. If multiple auxiliary force generators are installed at a single door body 13, each respective spring force of the coil spring 33a may be varied, or the spring force may be uniform and without variation.

In the case of the floating flap gate apparatus 1 having the above configuration according to the present invention, when the door bodies 13 and 22 rise, the water pressure load operating on the door bodies 22 of the corner flap gate 21 is transmitted via the hinge structures 32 and 31 to the floating flap gates 11 and 12 on both sides. In addition, the floating flap gates 11 and 12 are supported by tension rods 14 and by a bottom support member that bolsters the floating flap gates 11 and 12 (see FIG. 7).

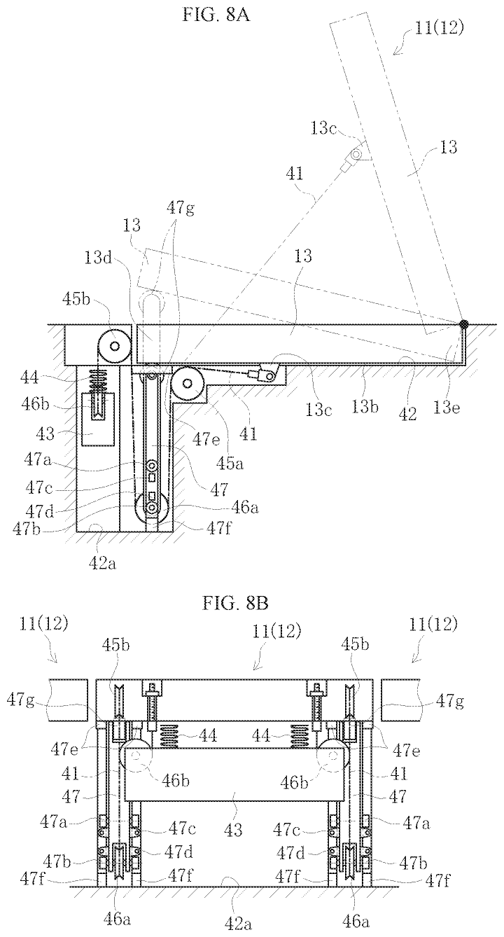

In the present invention, there are no particular restrictions on the construction of the floating flap gates 11 and 12 installed in the rectilinear regions S1 and S2. However, it is advantageous to select a structure such as that shown in FIG. 8, in the case of a site where it is typically impossible to build a bulky structure such as a building or underground space with a wide opening, or a lock gate or an end portion of the runway R, or a site where one wishes to limit a height of a bulky structure such as a dike or a levee that would block a scenic view.

In further detail, in the floating flap gates 11 and 12 illustrated in FIG. 8, one end of a wire rope 41 is attached to a back side 13b of the door body 13 in a lowered state. The wire rope 41 is arranged such that a bracket 13c is attached to a center portion in a height direction of the door body 13 on the back side 13b of the door body 13, for example, so that one end of the wire rope 41 is attached to the bracket 13c. The other end of the wire rope 41 is retracted into an underground space 42a formed in a storage space 42 for the door body 13 in a position facing the bracket 13c at the forward end side of the door body 13.

Within the underground space 42a are installed a counterweight 43, a compression spring 44 provided on both sides of the upper surface of the counterweight 43, and a group of connected pulleys that includes two fixed pulleys 45a and 45b, and two movable pulleys 46a and 46b. The other end of the retracted wire rope 41 is guided by the group of pulleys to an upper end of the counterweight 43. The counterweight 43, which has a width slightly smaller than that of the door body 13, hangs downward due to being affixed to a ceiling portion of the underground space 42a in this position.

Among the group of pulleys, the first fixed pulley 45a is disposed at the retracted portion of the wire rope 41 in the underground space 42a, while the second fixed pulley 45b is disposed at the ceiling portion of the underground space 42a which is the upper hanging position of the counterweight 43.

On the other hand, the first movable pulley 46a is rotatably attached to at a lower end of a push-up rod 47 that moves vertically between the first fixed pulley 45a and the second fixed pulley 45b. The second movable pulley 46b is attached to the counterweight 43.

When the push-up rod 47 moves vertically, motion toward a forward end side 13a and a base end side 13e of the door body 13 in a lowered state is restricted by upper and lower guide rollers 47a and 47b. Moreover, movement of the door body 13 in a lateral direction is restricted by upper and lower side rollers 47c and 47d. In addition, the vertical rising and falling movement of the push-up rod 47 is restricted by an upper-limit stopper 47e and a lower-limit stopper 47f, and a push-up roller 47g is attached at the upper end.

When raising the door bodies 13 and 22, and when lowering the gates bodies 13 and 22, the floating flap gates 11 and 12 and the corner flap gate 21 having an auxiliary mechanism for opening and closing the door bodies 13 that includes the first and second fixed pulleys 45a and 45b, the first and second movable pulleys 46a and 46b, the counterweight 43, and the push-up rod 47 operate as described below.

### When Raising the Door Bodies 13 and 22:

When a water infiltration reaches a predetermined level, and a buoyancy operating on the door bodies 13 and a rotational force in the direction of raising resulting from an upward-pushing force of the push-up rod 47 exerted by the counterweight exceed the rotational force in the direction of lowering due to the weight of the door bodies 13, the door bodies 22 start to float when the door bodies 13 start to float.

After the push-up rod 47 reaches its raising limit, the rotational force in the direction of raising resulting from water pressure operating on the immersed portions of the back surfaces 13b of the door bodies 13 exceeds the rotational force in the direction of lowering due to tension generated in the wire rope 41 caused by the weight of the door bodies 13 and the counterweight 43. This results in the door bodies 13 rotating and rising in the direction of raising. The door bodies 22 also rise together with the rising of the door bodies 13.

When the door bodies 13 rise to their raising limit, the counterweight 43 moves to the vicinity of its raising limit, and the compression spring 44 is compressed. Consequently, the tension of the wire rope 41 caused by the weight of the counterweight 43 and the compressive force of the compression spring 44 operates in the direction of lowering as a braking force on rotation of the door bodies 13 in the direction of raising.

### When Lowering the Door Bodies 13 and 22:

When there is a decrease in the rotational force in the raising direction resulting from water pressure operating on the immersed portions of the back surfaces 13b of the door bodies 13, the door bodies 13 rotate in the direction of lowering up to a position where there is an equilibrium with the rotational force in the direction of lowering due to tension generated in the wire rope 41 caused by the weight of the door bodies 13 and the counterweight 43. The door bodies also start to rise together with the rising of the door bodies 13. In the vicinity of the upper limit of raising, the compressive spring force adds to the tension generated in the wire rope 41.

While the rotational force in the lowering direction resulting from tension generated on the wire rope 41 by the weight of the door bodies 13 and the counterweight 43 and the rotational force in the direction of raising resulting from water pressure operating on the immersed portions of the back surfaces 13b of the door bodies 13, the door bodies 13 rotate in the direction of lowering. The rotational force in the direction of lowering increases due to the weight of the door bodies 13, but after the push-up rod 47 makes contact with the back surfaces 13b of the door bodies 13, the lowering action decelerates due to the rotational force in the direction of raising resulting from the upward-pushing force of the push-up rod 47. The door bodies 22 also lower together with the lowering of the door bodies 13.

When there is no longer a buoyancy caused by water pressure operating on the immersed portions of the back surfaces 13b of the door bodies 13, the door bodies 13 and 22 are inserted into the storage space 42. When this happens, the upward-pushing force of the push-up rod 47 due to the counterweight 43 eases its impact during the insertion due to the upward-pushing force of the push-rod 47, even though there is no rotational force in the direction of raising that is superior to the rotational force in the direction of lowering caused by the weight of the door bodies 13.

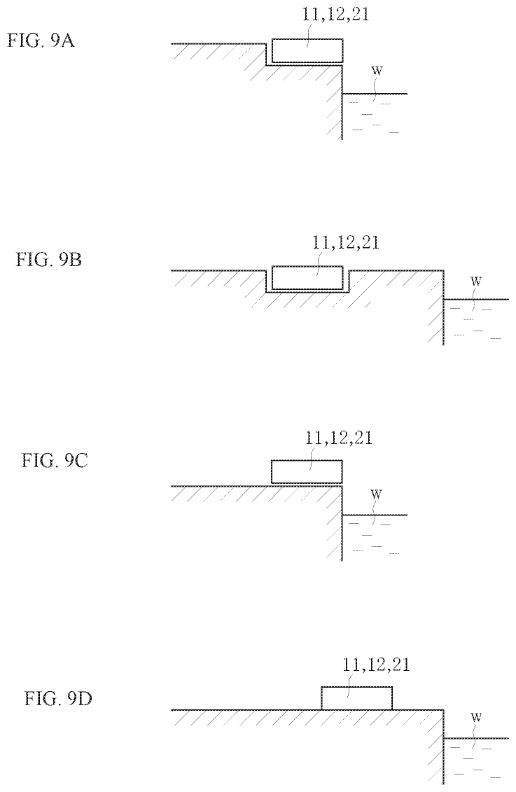

In cases where it is typically impossible to build a bulky structure such as an end portion of the runway R, storage of the floating flap gates 11 and 12 and the corner flap gates 21 is accomplished in a boundary area between the land and water as illustrated in FIG. 9A, or in a recessed area disposed in a land area adjacent to the water and formed in the same plane as the land area as illustrated in FIG. 9B.

On the other hand, in cases where a bulky structure such as a dike does not disturb the view, storage is accomplished in a boundary area between the land and water as illustrated in FIG. 9C, or on a top surface of the land adjacent to the water as illustrated in FIG. 9D.

The present invention is not limited to the above-described example, and the preferred embodiment may, of course, be advantageously modified within the scope of the technical ideas recited in the claims.

For example, according to the above example, in the corner flap gate 21, the hinge structure 32 has a double structure, with a rubber membrane 32a, and a fiber membrane 32b, serving to maintain a water-impervious state for the right-side door body 24 and the central door body 23, and the central door body 23 and the left-side door body 25, respectively (see FIG. 3C).

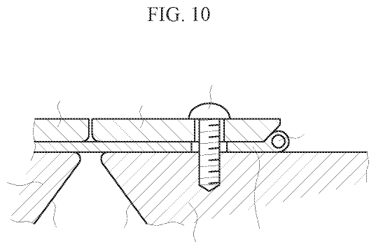

However, as shown in FIG. 10, a fiber-reinforced rubber 32h may be used as a rubber lining for a fiber material possessing tensile strength to maintain water-imperviousness.

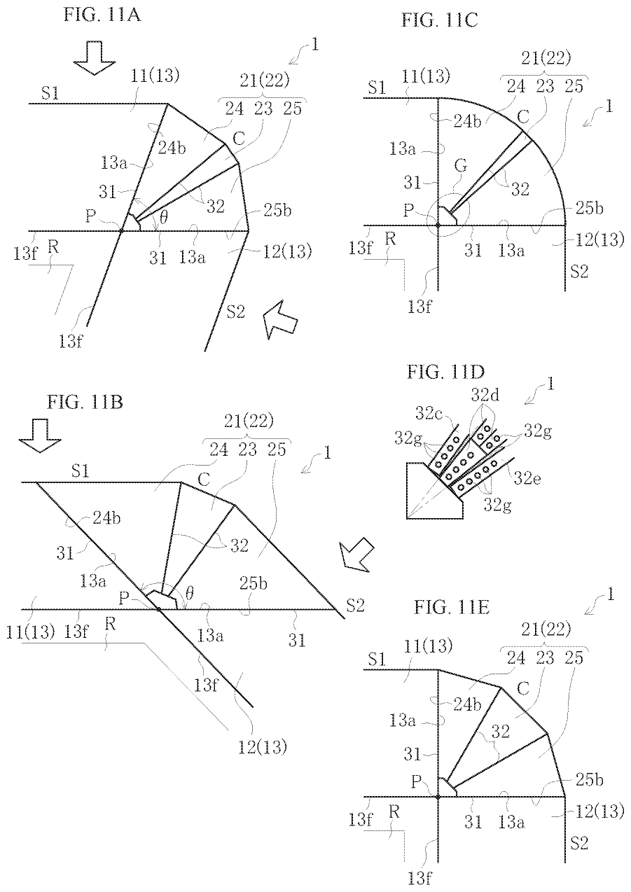

The above example describes a case where an angle θ of the corner portion C is 90°. However, as shown in FIG. 11A, the angle θ of the corner portion C may be less than 90°. Conversely, as shown in FIG. 11B, the angle θ of the corner portion C may exceed 90°.

Additionally, in the above example, because raising of the right-side door body 24 and the left side door body 25 are made easier due to the buoyancy or the auxiliary force generator 33, the right-side door body 24 and the left-side door body 25 were made as large as possible, and the central door body 23 was made as small as possible. In this case, the minimum value for the width L1 of the base end side of the central door body 23 is a width that enables attachment of the presser plate 32d, as shown in FIGS. 11C and 11D. However, as shown in FIG. 11E, the central door body 23, the right-side door body 24, and the left-side door body 25 may be divided into equal angles with the point P at the center.

In the above example, the forward end surfaces of the central door body 23, the right-side door body 24, and the left-side door body 25 form straight lines when in a lowered state when viewed from above. However, as shown in FIG. 11C, the forward end surfaces of the central door body 23, the right-side door body 24, and the left-side door body 25 may form convex curves.

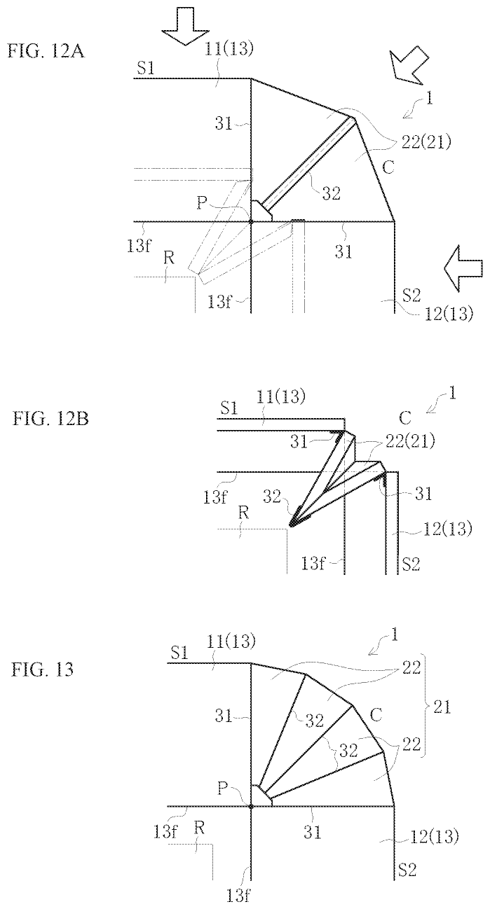

Moreover, in the above example, the door bodies 22 of the corner flap gate 21 are formed from three gate bodies: the central door body 23, the right-side door body 24, and the left-side door body 25. However, the number of door bodies forming the door bodies 22 may be two, as shown in FIG. 12. If the door bodies can be raised when positioned in the central portion and dependent on a buoyancy alone, then the number of door bodies may be four, as shown in FIG. 13.

In the various types of examples described above, the height and thickness of the door bodies 13 of the two floating flap gates 11 and 12 are determined by devising an optimized design so as to make it possible for the door bodies 13 to rise and descend according to a known angle θ of the corner portion C. This likewise applies to the number, configuration, height, and thickness of the door bodies 22 of the corner flap gate 21.

### EXPLANATION OF THE REFERENCE NUMERALS

1 Floating flap gate apparatus
11, 12 Floating flap gates
13 Door body
13a Side surface
13d Forward end side
13e Base end side
13f Bottom surface
21 Corner flap gate
22 Door body
23 Central door body
24 Right-side door body
25 Left-side door body
31, 32 Hinge structures
33 Auxiliary force generator
41 Wire rope
42 Storage space
42a Underground space
43 Counterweight
45a First fixed pulley
45b Second fixed pulley
46a First movable pulley
46b Second movable pulley
47 Push-up rod
S1 First rectilinear region
S2 Second rectilinear region
C Corner portion
θ Angle of the corner portion

1. A floating flap gate apparatus constructed to prevent an influx of a rising water, the floating flap gate comprising a door body configured such that a forward end of the door body swings upwards around a base end thereof within a plane in a height direction in a direction in which the water flows in, the floating flap gate apparatus comprising:
a floating flap gate arranged in a first rectilinear region and in a second rectilinear region; and a corner flap gate disposed in a corner portion where the first and second rectilinear regions intersect, wherein
the corner flap gate has a plurality of door bodies divided by straight lines passing through a part where lines extending in a width-wise direction of a base end side bottom surface of the door bodies of said two floating flap gates intersect at the corner portion, and
two adjacent ones of the plurality of door bodies are connected by a hinge structure that maintains a water-impervious state, and among the plurality of door bodies, a door body adjacent to a door body of the floating flap gates and the door body of the floating flap gate are connected by a hinge structure that maintains the respective water-impervious states.

2. The floating flap gate apparatus according to claim 1, wherein the corner flap gate is formed on a base end side of the plurality of door bodies with a notched site that includes a part intersected by the corner portion, the notched site being covered with a water-impervious membrane that maintains a water-impervious state in the hinge structure.

3. The floating flap gate apparatus according to claim 1, wherein a side surface of a rectilinear region side of one of the a door bodies of the floating flap gate arranged in the other rectilinear region in a lowered state, and a bottom surface of a floating flap gate arranged in another rectilinear region in a lowered state, are formed in a single straight line when viewed from above.

4. The floating flap gate apparatus according to claim 1, wherein the plurality of door bodies forming the corner flap gate comprises a central door body, and a right-side door body and a left-side door body arranged on both sides of the central door body.

5. The floating flap gate apparatus according to claim 1, wherein the hinge structure is arranged on a surface side of the two floating flap gates and the corner flap gate in a lowered state.

6. The floating flap gate apparatus according to claim 1, wherein an auxiliary force generator is provided at the door body of the corner flap gate and at the door body of the adjacent floating flap gate, in order to provide an auxiliary force in the folding direction of the door bodies, to assist in raising when the corner flap gate rises

7. The floating flap gate apparatus according to claim 1, wherein the floating flap gates have an auxiliary mechanism for opening and closing the door bodies, the mechanism comprising:
two fixed pulleys and two movable pulleys arranged within an underground space formed at a forward end side of the door bodies;
a counterweight attached to a ceiling of the underground space formed at the forward end side of the door bodies and guided by the two fixed pulleys and movable pulleys and attached to a second movable pulley that guides a rope; and
a push-up rod attached to a first movable pulley, disposed within a storage space for storing the door bodies when lowered, with one end of a rope being attached to a back side of the door body in a lowered state;
the mechanism serving to prevent an upward-pushing of the forward end side of the door bodies when the door bodies start to rise and to prevent a sudden falling when the door bodies start to lower by causing the push-up rod to move up and down, utilizing a vertical motion of the counterweight, and
the mechanism also serving to absorb an impact when the door bodies start to rise and that follow a water level when the door bodies start to lower.
